(19) United States
(12) Patent Application Publication
(10) Pub. No.: US 2024/0215083 A1
(43) Pub. Date: Jun. 27, 2024

(54) A METHOD FOR MANAGING INTERNET CONNECTION OF AN APPLIANCE

(71) Applicant: ELECTROLUX APPLIANCES AKTIEBOLAG, Stockholm (SE)

(72) Inventors: James FISHER, Charlotte, NC (US); Jason BENSKIN, Stockholm (SE); Vivek HAKIM, Charlotte, NC (US); Mauro TAIARIOL, Porcia (IT); Filippo BOATTO, Porcia (IT)

(73) Assignee: ELECTROLUX APPLIANCES AKTIEBOLAG, Stockholm (SE)

(21) Appl. No.: 18/579,910

(22) PCT Filed: Jul. 19, 2021
(86) PCT No.: PCT/EP2021/070071

§ 371 Date: Jan. 17, 2024

(51) Int. Cl. H04W 76/10; H04W 4/30; H04W 84/12

(52) U.S. Cl. CPC H04W 76/10; H04W 4/30; H04W 84/12

(57) ABSTRACT

A method for connecting an appliance (100) to an external server (120) connected to the internet is provided. The method comprises setting-up, with the appliance, a first appliance access point (AP1) for allowing wireless communication with the appliance using a first wireless technology and a second appliance access point (AP2) for allowing wireless communication with the appliance using a second wireless technology, said first technology comprising Wi-Fi technology, and said second technology being different from said first technology. The method further comprises setting-up a wireless link between a mobile device (130) and a selected appliance access point between said first and said second appliance access points (AP1; AP2).

### FIELD OF THE INVENTION

The solution according to embodiments of the present invention generally relates to the appliance field. More specifically, the solution according to embodiments of the present invention relates to a method for managing internet connection of an appliance.

### BACKGROUND OF THE INVENTION

A modern appliance (for domestic or professional use) is usually equipped with communication hardware configured to interface with the internet in order to be able to communicate with a remote entity, such as a server.

For example, the server may belong to a cloud computing system configured to implement a service environment adapted to provide service functions for improving the functionality of the appliance. For instance, the appliance may receive from the service environment new firmware updates and additional configurations.

The communication hardware of the appliance may comprise a communication unit configured to establish communication with the internet (and therefore with the server) through an internet access point, for example set-up by a router device.

In order to access the internet access point set-up by the router device, a wireless communication link (e.g., a Wi-Fi link) has to be established between the appliance and the router device. For this reason, the appliance has to be properly configured, with the provision of corresponding wireless credentials.

The configuration of the appliance, and particularly the provision of the wireless credentials to the latter for establishing the wireless communication link between the appliance and the router device, may be carried out by exploiting a mobile device (such as a smartphone).

For this reason, data communication between the mobile device and the appliance has to be enabled by establishing a wireless communication link between the appliance and the mobile device.

According to a solution known in the art, the wireless communication link between the appliance and the mobile device is a Wi-Fi link between the Wi-Fi communication unit of the mobile device and a Wi-Fi access point set-up by the communication hardware of the appliance.

### SUMMARY OF THE INVENTION

The Applicant has found that the known solutions for connecting an appliance to a remote entity, such as a server, are affected by drawbacks.

The known solutions provide for having a user of the appliance connect a mobile device to the appliance through a dedicated Wi-Fi link. The operations required to configure the communication hardware of the appliance and of the mobile device for establishing said dedicated Wi-Fi are not easy, and a user not accustomed to configure network devices may incur into obstacles preventing the correct outcome of the operations.

Moreover, the known solutions lacks of flexibility, since according to the known solutions the connection between the mobile device and the appliance is entirely based on a single communication technology (the Wi-Fi technology).

Furthermore, another serious drawback affecting the known solutions being entirely based on the Wi-Fi technology is that when a user is trying to establish communication between the appliance and the mobile device, if the mobile device was connected to the internet access point set-up by the router through a previously established Wi-Fi link, said Wi-Fi link has to be temporarily disabled, forcing a temporary interruption of said connection between the mobile device and the internet access point.

In view of the above, the Applicant has devised a method for connecting an appliance to a remote entity which is not affected by the abovementioned drawbacks.

An aspect of the present invention relates to a method for connecting an appliance to an external server connected to the internet.

The method comprises having the appliance set-up a first appliance access point for allowing wireless communication with the appliance using a first wireless technology and a second appliance access point for allowing wireless communication with the appliance using a second wireless technology.

Said first technology comprises Wi-Fi technology.

Said second technology is different from said first technology.

The method further comprises having a wireless link be set-up between a mobile device and a selected appliance access point between said first and said second appliance access points.

The method further comprises having the mobile device exploit said wireless link for providing to the appliance credentials for allowing wireless communication between the appliance and an internet access point.

The method further comprises having the appliance connect to the internet access point exploiting said credentials.

The method further comprises having the appliance connect to the external server through said internet access point.

In this way, two different and concurrent access points are enabled to access the appliance, each one configured to enable a data communication with the appliance with a different wireless communication technology. Therefore, the data communication between the mobile device and the appliance required for the configuration of the latter during the connection to the server may be set-up with a higher flexibility.

Moreover, if the mobile device connects to the appliance through a wireless involving the second appliance access point (i.e., using a wireless technology different from the Wi-Fi technology), there is no need to temporarily disable possible already established Wi-Fi data connections of the mobile device with other communication devices.

According to an embodiment of the present invention, said second technology comprises one among:
Bluetooth technology;
Near-Field Communication technology;
Radio sub Giga technology;
ZigBee technology;
optical communication technology.

According to an embodiment of the present invention, the appliance comprises a first wireless communication unit configured to be activated to set-up said first access point and a second wireless communication unit configured to be activated to set-up said second access point.

According to an embodiment of the present invention, the method further comprises having the appliance activate the first wireless communication unit and the second communication unit.

According to an embodiment of the present invention, the method further comprises having the first wireless communication unit enable broadcast of first access information for accessing the first access point.

According to an embodiment of the present invention, the method further comprises having the second wireless communication unit enable broadcast of second access information for accessing the second access point.

According to an embodiment of the present invention, the method further comprises, after the set-up of the wireless link between the mobile device and said selected appliance access point, having the appliance deactivate a wireless communication unit between the first wireless communication unit and the second wireless communication unit that is different from the wireless communication unit configured to set-up the selected appliance access point.

In this way, the management of the wireless communication units is advantageously simplified.

According to an embodiment of the present invention, the appliance further comprises a third wireless communication unit.

According to an embodiment of the present invention, said having the appliance connect to the internet access point comprises having said third wireless communication unit be activated to establish a Wi-Fi link between the appliance and the internet access point.

According to an embodiment of the present invention, the method further comprises having the appliance deactivate both the first wireless communication unit and the second wireless communication unit after the appliance is connected to the internet access point.

The deactivation of both the first wireless communication unit and the second wireless communication after the establishment of a connection between the appliance and the internet access point allows to simplify the management of the wireless communication units.

According to an embodiment of the present invention, said having a wireless link be set-up between the mobile device and a selected appliance access point between said first and said second appliance access points comprises:
having the mobile device collect a selected access information between said broadcasted first and second access information;
having the mobile device access said selected access point exploiting the selected access information.

According to an embodiment of the present invention, said first access information comprises a first name identifying said first access point.

According to an embodiment of the present invention, said second access information comprises a second name identifying said second access point.

According to an embodiment of the present invention, each of said first access information and said second access information further comprise a same identifier univocally identifying the appliance.

In this way, an easier appliance recognition can be performed, strongly improving the user experience.

According to an embodiment of the present invention, said identifier comprises a MAC address associated to the appliance.

According to an embodiment of the present invention, said internet access point is set-up by a router device external to the appliance.

### BRIEF DESCRIPTION OF THE ANNEXED DRAWINGS

These and other features and advantages of the present invention will be made apparent by the following description of some exemplary and non limitative embodiments thereof; for its better intelligibility, the following description should be read making reference to the attached drawings, wherein:

FIG. 1 illustrates an exemplary system according to embodiments of the present invention;

FIGS. 2A, 2B depict the main phases of a method for connecting the appliance to the external server of the system of FIG. 1 according to an embodiment of the present invention.

### DETAILED DESCRIPTION OF PREFERRED EMBODIMENTS OF THE INVENTION

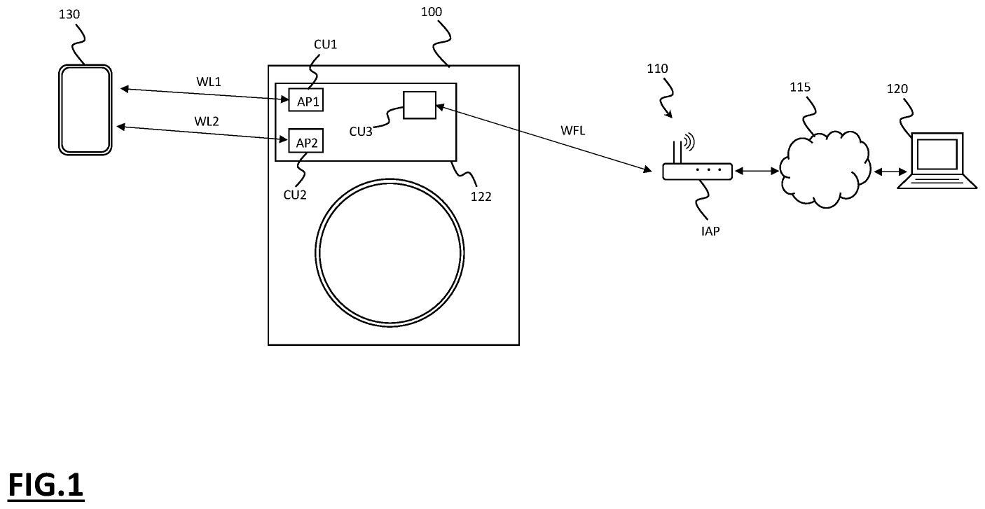

FIG. 1 illustrates an exemplary system according to embodiments of the present invention.

The system according to an embodiment of the present invention comprises an appliance 100, such as an appliance for domestic use or an appliance for professional use.

In the illustrated example, the appliance 100 is a laundry machine, such as a laundry washing machine configured to wash laundry, a laundry dryer machine configured to dry laundry, or a combined laundry washing and drying machine configured to wash and dry laundry. However, the concepts of the present invention directly apply to other kinds of appliances, both for domestic and professional use, such as for example refrigerators, dishwashers, cooking hobs, ovens.

The system according to an embodiment of the present invention further comprises a router device 110 configured to set-up an internet access point IAP for allowing communication with an external network, such as the internet 115.

Making for example reference to a domestic scenario, wherein the appliance 100 is a domestic appliance located inside a home, the internet access point IAP set-up by the router device 110 may be an access point (also) used by other appliances and electronic devices (e.g., smartphones, television sets, personal computers) located in the home for accessing the internet 115.

According to an embodiment of the present invention, the appliance 100 is configured to exchange data with an (external) server 120 connected to the internet 115. For example, the server 120 may be configured to implement a service environment SE (e.g., managed by the manufacturer of the appliance 100) adapted to provide service functions for improving the functionality of the appliance 100. For instance, exploiting the service environment SE, the appliance 100 may receive new firmware updates and additional configurations. It is pointed out that while in the considered example the service environment SE is implemented by a single unit, i.e., the server 120, similar considerations if the service environment is implemented by a distributed system, such as a cloud computing system distributed over a plurality of servers.

According to an embodiment of the present invention, the appliance 100 comprises a network communication module 122 configured to allow data communication between the appliance 100 and external entities connected to the internet 115 (such as the external server 120) through the internet access point IAP set-up by the router device 110. For this purpose, according to an embodiment of the present invention, the network communication module 122 is configured to set-up a Wi-Fi link WFL between the appliance 100 and the internet access point IAP.

In order to allow the set-up of the Wi-Fi link WFL and to access the internet access point IAP, the appliance 100 requires to be properly configured with the provision of corresponding wireless credentials WC, e.g., comprising a SSID (Service Set IDentifier) and a password.

According to an embodiment of the present invention, the configuration of the appliance 100 is carried out through a mobile device 130, such as a smartphone.

According to an embodiment of the present invention, the mobile device 130 is configured to manage the operations for the configuration of the appliance 100 exploiting a corresponding service application APP that may be installed in the mobile device 130. For example, the service application APP may be an application which is (also) configured to allow interaction with the service environment SE implemented by the server 120. For instance, the service application APP may be managed by the same entity that manages the service environment SE.

According to an embodiment of the present invention, the configuration of the appliance 100 through the mobile device 130 provides that a direct data communication is enabled between the appliance 100 and the mobile device 130.

For this purpose, according to an embodiment of the present invention, the appliance 100 is configured to set-up:
a first access point AP1 for allowing wireless communication with the appliance 100 using the Wi-Fi technology, and
a second access point AP2 for allowing wireless communication with the appliance 100 using a wireless technology different from the Wi-Fi technology.

According to an embodiment of the invention, said wireless technology different from the Wi-Fi technology comprises one among Bluetooth technology, Near-Field communication technology, Radio sub Giga technology, ZigBee technology, and optical communication technology.

According to an embodiment of the present invention, a direct data communication is enabled between the mobile device 130 and the appliance 100 by having the mobile device 130 accessing a selected one between the two access points AP1, AP2.

In this way, according to an embodiment of the present invention, a wireless link is established between the mobile device 130 and a selected one between the access point AP1 and the access point AP2, and particularly a wireless link WL1 between the mobile device 130 and the access point AP1 or a wireless link WL2 between the mobile device 130 and the access point AP2.

It is pointed out that according to an embodiment of the present invention, the appliance 100 is configured to have both the access points AP1 and AP2 be concurrently active, so that the mobile device 130 is granted the possibility of a double choice for accessing the appliance 100.

Thanks to the proposed solution, in which two different and concurrent access points AP1, AP2 are enabled, each one configured to enable a data communication with the appliance 100 with a different wireless communication technology, the data communication between the mobile device 130 and the appliance 100 required for the configuration of the latter during the connection to the server 120 may be set-up with a higher flexibility.

Moreover, if the mobile device 130 connects to the appliance 100 through the wireless link WL2 (i.e., using a wireless technology different from the Wi-Fi technology), there is no need to temporarily disable possible already established Wi-Fi data connections of the mobile device 130 with other communication devices, such as the router device 110, since the wireless link WL2 does not involve the use of the Wi-Fi communication module (not illustrated) of the mobile device 130.

According to an embodiment of the present invention, the access points AP1 and AP2 are set-up by the network communication module 122.

According to an embodiment of the present invention, the network communication module 122 comprises a first wireless communication unit CU1 configured to be activated to set-up the first access point AP1. According to an embodiment of the present invention, the first wireless communication unit CU1 is a Wi-Fi communication unit.

According to an embodiment of the present invention, the network communication module 122 further comprises a second wireless communication unit CU2 configured to be activated to set-up the second access point AP2. According to an embodiment of the present invention, the second wireless communication unit CU2 is a Bluetooth communication unit, a Near-Field communication unit, a Radio sub Giga communication unit, a ZigBee communication unit, or an optical communication unit.

According to an embodiment of the present invention, the network communication module 122 further comprises a third wireless communication unit CU3 configured to be activated to establish the Wi-Fi link WFL between the appliance 100 and the internet access point IAP.

According to an embodiment of the present invention, once a selected wireless link WL1 or WL2 has been established between the mobile device 130 and the appliance 100, said selected wireless link is exploited by the mobile device 130 for providing the appliance 100 with the wireless credentials WC for accessing the internet access point IAP. For example, the provision of the wireless credentials WC over the selected wireless link WL1 or WL2 may be carried out by the mobile device 130 under the control of the service application APP installed thereat.

According to an embodiment of the present invention, the appliance 100 is configured to connect to the internet access point IAP through the Wi-Fi link WFL by exploiting the received wireless credentials WC.

Once the appliance 100 is able to access the internet 115 through the internet access point IAP, a data connection with the external server 120 can be established. In this way, the appliance 100 is able to interact with the service environment SE implemented by the server 120 for availing itself of the services offered by the service environment SE. For example, a user of the service application APP (e.g., the owner of the appliance 100) having a personal user account with the service environment SE may register the appliance 100 with the service environment SE so as to bind the appliance 100 with his/her personal user account. In this way, the appliance 100 may benefit from customized services provided by the service environment SE, such as for example new firmware updates and/or additional configurations specifically tailored for the appliance 100.

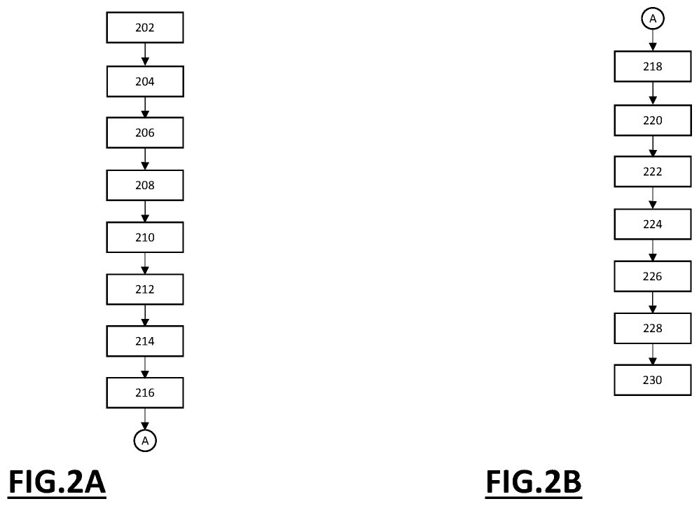

By making reference to FIGS. 2A-2B, the main phases of a method for connecting the appliance 100 to the external server 120 according to an embodiment of the present invention are illustrated in terms of functional blocks.

The method according to an embodiment of the present invention starts with the appliance 100 that activates both the first wireless communication unit CU1 and the second wireless communication unit CU2 of the network interface unit 122 to set-up both the first access point AP1 and the second access point AP2 (block 202).

Then, according to an embodiment of the present invention, the two activated access points AP1 and AP2 advertise themselves, by having the first wireless communication unit CU1 and the second wireless communication unit CU2 enable broadcast of corresponding access information AI1, AI2, respectively (block 204).

According to an embodiment of the present invention, the access information AI1 broadcasted by the first wireless communication unit CU1 is a not-hidden and not-encrypted Wi-Fi SSID. According to a preferred embodiment of the present invention, said Wi-Fi SSID comprises a first name univocally identifying the appliance 100. According to an embodiment of the present invention, said access information AI1 comprises a unique string in a predefined format comprising at least one among an identifier of the type of the appliance 100, a MAC address of the appliance 100, a PNC-ELC of the appliance 100, a serial number of the appliance 100.

According to an embodiment of the present invention, the access information AI2 broadcasted by the second wireless communication unit CU2 is an identifier message (depending on the wireless communication technology implemented by the second wireless communication unit CU2, such as for example a Bluetooth message in case of Bluetooth technology), preferably comprising a first name univocally identifying the appliance 100. According to an embodiment of the present invention, said access information AI2 comprises a unique string in a predefined format comprising at least one among an identifier of the type of the appliance 100, a MAC address of the appliance 100, a PNC-ELC of the appliance 100, a serial number of the appliance 100.

According to an embodiment of the present invention, said access information AI1 and said access information AI2 comprise a same identifier univocally identifying the appliance 100.

According to an embodiment of the present invention, the mobile device 130 receives the access information AI1 and AI2, and preferably displays information about the availability of the two activated access points AP1 and AP2 to the user of the mobile device 130 (block 206). Preferably this information is provided through the service application APP.

It is pointed out that in order to being able to receive both the two access information AI1 and AI2, the mobile device 130 requires that corresponding wireless communication hardware modules thereof are enabled. More particularly, in order to receive the access information AI1, a Wi-Fi communication module (not illustrated) of the mobile device 130 has to be enabled. In order to receive the access information AI2, a wireless communication module (not illustrated) operating according to the technology of the second wireless communication unit CU2 has to be enabled. For example, if the second wireless communication unit CU2 is a Bluetooth communication unit, the mobile device 130 is able to receive the access information AI2 only if the Bluetooth communication unit of the mobile device 130 is enabled.

According to an embodiment of the present invention, the mobile device 130 selects one between the available activated access points AP1 and AP2 and connects to it by collecting and exploiting a corresponding access information between the access information AI1 and AI2, thus setting-up a wireless link (the wireless link WL1 or the wireless link WL2) between the mobile device 130 and the appliance 100 (block 208). Preferably, the selection of the access point and the activation of the corresponding wireless link is managed by the service application APP itself, relieving the user from carrying out laborious and time consuming operations. Alternatively, the selection of the access point and the activation of the corresponding wireless link may be carried out by the mobile device 130 under the direct control of the user.

At this point, data communication between the mobile device 130 and the appliance 100 is enabled through the wireless link WL1 or WL2 that has been set-up.

According to an embodiment of the present invention, once an access point AP1 or AP2 is selected, and the corresponding wireless link WL1 or WL2 is set-up, the communication unit CU2 or CU1 having set-up the other (e.g., unselected) access point AP2 or AP1 is deactivated (block 210).

At this point, according to an embodiment of the present invention, the network communication unit 122 of the appliance 100 exploits the wireless link WL1 or WL2 that has been set-up for sending to the mobile device 130 a list of Wi-Fi internet access points (including the internet access point IAP set-up by the router device 110) seen by the network communication unit 122 (block 212).

According to an embodiment of the present invention, the mobile device 130 displays the available Wi-Fi internet access points (including the internet access point IAP set-up by the router device 110) seen by the network communication unit 122 by using the list received from the network communication unit 122 of the appliance 100 (block 214).

At this point, according to an embodiment of the present invention, and preferably using the service application APP, the user of the mobile device 130 may select the internet access point IAP and cause a sending of the wireless credentials WC, e.g., SSID and password, for accessing the internet access point IAP from the mobile device 130 to the appliance 100 over the wireless link WL1 or WL2 that has been set-up (block 216).

Then, according to an embodiment of the present invention, the network communication unit 122 of the appliance 100 connects to the internet access point IAP by activating the third communication unit CU3 and using the received wireless credentials WC, so that a Wi-Fi link WFL is set-up between the appliance 100 and the internet access point IAP (block 218). In this way, the appliance 100 is now able to access the internet 115.

According to a preferred embodiment of the present invention, the received wireless credentials WC are advantageously stored by the appliance 100 (block 220) for being used for future connections to the internet access point IAP.

According to an embodiment of the present invention, and preferably using the service application APP, the mobile device 130 provides the appliance 100 with a specific pointer PT to the server 120, exploiting the wireless link WL1 or WL2 that has been set-up (block 222).

According to an embodiment of the present invention, the network communication unit 122 of the appliance 100 uses the received pointer PT to determine an internet address of the server 120 and request (through the internet 115) server access information SAI (e.g., a security key) for accessing the server 120 to a web portal associated to the service environment SE (block 224).

According to an embodiment of the present invention, the network communication unit 122 of the appliance 100 receives (through the internet 115) the requested server access information SAI from the web portal (block 226).

According to an embodiment of the present invention, the network communication unit 122 of the appliance 100 connects to the server 120 (through the internet 115) exploiting said received server access information SAI and, for example, one or more among a MAC address of the appliance 100, a PNC-ELC of the appliance 100, and a serial number of the appliance 100 (block 228).

Then, according to an embodiment of the present invention, and preferably through the service application APP, the mobile device 130 requests to turn off the wireless link WL1 or WL2 that has been set-up, causing the deactivation of both the first and second communication units CU1 and CU2 (block 230).

Now, the appliance 100 is connected to the server 120, and data communication between the appliance 100 and the server 120 is enabled. In this way, the appliance 100 is able to interact with the service environment SE implemented by the server 120.

For example, the user may register the appliance 100 with the service environment SE through the service application APP by binding the appliance 100 with his/her personal user account exploiting:
an identifier of the appliance 100 (e.g., comprising one or more among a MAC address of the appliance 100, a PNC-ELC of the appliance 100, and a serial number of the appliance 100), and
appliance purchase information data (e.g., the purchase date of the appliance 100).

Once the appliance 100 is registered with the service environment SE, the appliance 100 may benefit from customized services provided by the service environment SE, such as for example receiving from the server 120 new firmware updates and/or additional configurations specifically tailored for the appliance 100.

Naturally, in order to satisfy local and specific requirements, a person skilled in the art may apply to the solution described above many logical and/or physical modifications and alterations. More specifically, although the present invention has been described with a certain degree of particularity with reference to preferred embodiments thereof, it should be understood that various omissions, substitutions and changes in the form and details as well as other embodiments are possible. In particular, different embodiments of the invention may even be practiced without the specific details set forth in the preceding description for providing a more thorough understanding thereof; on the contrary, well-known features may have been omitted or simplified in order not to encumber the description with unnecessary details. Moreover, it is expressly intended that specific elements and/or method steps described in connection with any disclosed embodiment of the invention may be incorporated in other embodiments.

1. A method for connecting an appliance to an external server connected to an internet, comprising:
setting-up, with the appliance, a first appliance access point for allowing wireless communication with the appliance using a first wireless technology and a second appliance access point for allowing wireless communication with the appliance using a second wireless technology, said first technology comprising Wi-Fi technology, and said second technology being different from said first technology,
setting-up a wireless link between a mobile device and a selected appliance access point between said first and said second appliance access points;
receiving, with the appliance, from the mobile device, and via said wireless link, for providing to the appliance credentials for allowing wireless communication between the appliance and an internet access point;
connecting the appliance to the internet access point exploiting using said credentials; and
connecting the appliance to the external server through said internet access point.

2. The method of claim 1, wherein said second wireless technology is:
Bluetooth technology;
Near-Field Communication technology;
Radio sub Giga technology;
ZigBee technology; or
optical communication technology.

3. The method of claim 1, wherein the appliance comprises a first wireless communication unit configured to be activated to set-up said first appliance access point and a second wireless communication unit configured to be activated to set-up said second appliance access point, the method further comprising:
activating, with the appliance, the first wireless communication unit and the second wireless communication unit;
broadcasting, with the first wireless communication unit, first access information for accessing the first appliance access point; and
broadcasting, with the second wireless communication unit, second access information for accessing the second appliance access point.

4. The method of claim 3, further comprising:
after setting-up the wireless link between the mobile device and said selected appliance access point, having deactivating, with the appliance, a wireless communication unit between the first wireless communication unit and the second wireless communication unit that is different from the wireless communication unit configured to set-up the selected appliance access point.

5. The method of claim 3, wherein the appliance further comprises a third wireless communication unit, wherein connecting the appliance to the internet access point comprises activating said third wireless communication unit to establish a Wi-Fi link between the appliance and the internet access point.

6. The method of claim 3, further comprising:
deactivating, with the appliance, both the first wireless communication unit and the second wireless communication unit after the appliance is connected to the internet access point.

7. The method of claim 3, wherein setting up a wireless link between the mobile device and a selected appliance access point between said first and said second appliance access points comprises:
collecting, with the mobile device, a selected access information between said broadcasted first and second access information; and
accessing, with the mobile device, said selected appliance access point using the selected access information.

8. The method of claim 3, wherein:
said first access information comprises a first name identifying said first appliance access point; and
said second access information comprises a second name identifying said second appliance access point.

9. The method of claim 8, wherein each of said first access information and said second access information further comprise a same identifier univocally identifying the appliance.

10. The method of claim 9, wherein said identifier comprises a MAC address associated to the appliance.

11. The method of claim 1, wherein said internet access point is set-up by a router device external to the appliance.
